(19) United States
(12) Patent Application Publication
(10) Pub. No.: US 2025/0342381 A1
(43) Pub. Date: Nov. 6, 2025

(54) METHOD FOR DETERMINING PARAMETERS FOR A SET OF ATOM-TRAPPING SITES WITH A VIEW TO FORMING A PLURALITY OF NETWORKS OF QUBITS

(71) Applicant: PASQAL, MASSY (FR)

(72) Inventors: Loïc HENRIET, PALAISEAU (FR); Henrique Guimarães SILVERIO, PALAISEAU (FR); Adrien SIGNOLES, PALAISEAU (FR)

(21) Appl. No.: 18/855,521

(22) PCT Filed: Apr. 14, 2023
(86) PCT No.: PCT/EP2023/059782

§ 371 Date: Oct. 9, 2024

(30) Foreign Application Priority Data
Apr. 15, 2022 (FR) FR2203523

(51) Int. Cl. G06N 10/40; G06N 10/60

(52) U.S. Cl. CPC G06N 10/40; G06N 10/60

(57) ABSTRACT

The present invention relates to a method for determining parameters for a set of atom-trapping sites with a view to forming a plurality of networks of qubits allowing a quantum processor to process a set of predetermined tasks, the parameters defining at least a number of trapping sites and a spatial layout of the trapping sites, each network of qubits being able to be formed by atoms trapped in trapping sites, referred to as effective sites, of the set of sites, the other trapping sites, referred to as reservoir sites, being empty for the network of qubits under consideration, the reservoir sites being able to trap atoms that are able to be used to supply the effective sites during the formation of the network of qubits under consideration.

### TECHNICAL FIELD OF THE INVENTION

The present invention relates to a method for determining parameters for a set of atom-trapping sites with a view to forming a plurality of networks of qubits for processing a set of predetermined tasks by a quantum processor. The present invention relates to a method for determining a configuration of a quantum processor for processing a set a predetermined tasks. The present invention further relates to a computer program product.

### CONTEXT OF THE INVENTION

Neutral-atom quantum processors have many promising features for quantum computation and simulation. The features include the ability to reconfigure the geometry of the qubit register from one execution to another. Such feature comes from the possibilities of setting provided by the network of optical tweezers wherein the atoms are trapped. More particularly, the layout of the traps can be chosen in any arbitrary geometry 1D, 2D or even 3D, by means of suitable holographic methods. Before passing through a focusing lens, the trapping beam is reflected onto a spatial light modulator (SLM) that gives the beam an adjustable phase pattern. In the focal plane of the lens, the phase modulation is converted into an intensity pattern, thereby creating a network of traps.

Such possibility of reconfiguration is useful for many applications of quantum computing, for which it is suitable to modify the geometry of the qubit register according to the task to be accomplished. Examples of applications include the implementation of quantum machine learning methods on graph-structured data or solving quadratic unconstrained binary optimization (QUBO) problems. In the first example, the exact same sequence should be applied to many different qubit registers. In the second example, the geometry of the register is generally adapted to the problem to be solved. However, implementing a new geometry by modifying the phase model on the SLM can take a long time (up to an hour). Thereof is due to calibration problems. More particularly, after the calculation of the desired phase model and the implementation thereof, the depth of the traps should be equalized (equalizing the intensity of the traps). However, the long calibration time is detrimental to the implementation of procedures requiring tens or hundreds of different register geometries.

There is thus a need for a means of reducing the reconfiguration time of a network of qubits.

### SUMMARY OF THE INVENTION

To this end, the subject matter of the present description is a method for determining parameters for a set of atom-trapping sites with a view to forming a plurality of networks of qubits allowing a quantum processor to process a set of predetermined tasks, the parameters defining at least a number of trapping sites and a spatial layout of the trapping sites, each network of qubits being able to be formed by atoms trapped in trapping sites of the set of sites, referred to as effective sites, the other trapping sites, referred to as reservoir sites, being empty for the network of qubits under consideration, the reservoir sites being able to trap atoms that are able to be used to supply the effective sites during the formation of the network of qubits under consideration; the method being implemented by a computer and comprising the following steps:
obtaining, for each predetermined task, a matrix of positions, called a specific matrix, each specific matrix defining the positions of effective sites forming a network of qubits suitable for processing the predetermined task when an atom is trapped in each effective site, the predetermined tasks being suitable for being distributed into subsets of tasks, and
the determination, according to the specific matrices obtained, of a matrix of generic positions, called the generic matrix, for each subset of predetermined tasks, the generic matrix being different from each specific matrix of the subset concerned, the generic matrix defining positions of trapping sites complying with a set of constraints, at least one constraint stipulating that each position of the specific matrix of each task of the subset considered corresponds to a position, called the effective position, in the generic matrix,
for each predetermined task, the trapping sites apt to be positioned at the effective positions of the generic matrix corresponding to effective trapping sites for forming a network of qubits apt to process the predetermined task when an atom is trapped in each effective site, and the trapping sites apt to be positioned at the other positions of the generic matrix forming reservoir sites,
for each subset of tasks, the generic matrix and the set of actual positions corresponding to each task in the subset, forming the parameters of the trap sites of the subset of tasks.

According to other particular embodiments, the determination method comprises one or more of the following features, taken individually or according to all technically possible combinations:
the specific matrix of each predetermined task of each subset defines a number of effective sites for processing the predetermined task, at least one constraint stipulating that the number of trapping sites defined by the generic matrix is equal to twice the largest number of effective sites among each predetermined task of the subset concerned;
the determination step comprises a sub-step of distributing predetermined tasks into subsets according to the specific matrices obtained, the distribution sub-step comprising:
the determination of a matrix of distances between each specific matrix, and.
the distribution of the predetermined tasks into subsets, according to a clustering technique, depending upon the determined distance matrices, advantageously the clustering technique being based on a K-means clustering algorithm;
each task corresponds to the implementation of classification operations on a graph specific to the task, each graph having vertices and edges, the vertices of each graph defining the positions of the specific matrix of the corresponding task, or each task corresponds to solving an optimization problem, such as a quadratic unconstrained binary optimization problem.
the determination step comprising, for each subassembly, the following sub-steps of:
   provision of a reference matrix defining positions of atom trapping sites according to a reference pattern,
   determination, for a predetermined task of the subset, of positions of the reference matrix, referred to as generic positions, the number of generic positions being equal to the number of effective site positions of the specific matrix of the task, the generic positions being the positions of the reference matrix for which a distance from the positions of the specific matrix is minimal,
      the preceding determination sub-step being repeated for other predetermined tasks so as to maximize overlap with the generic positions already determined, the repetition taking place until an end of repetition criterion is reached, the set of generic positions determined forming trapping site positions of the generic matrix;
the end of repetition criterion is reached when the number of generic positions is equal to a predetermined number, the set of generic positions forming the set of trapping site positions of the generic matrix, the determination step comprising a possible sub-step of determining the positions of the effective sites of each possible predetermined task remaining among the generic positions alone, so as to minimize a distance from the positions of the specific matrix of the remaining task considered.

The present description further relates to a method of configuring a quantum processor for processing a set of predetermined tasks, the quantum processor comprising a generator of atom trapping sites and of atoms apt to be trapped in the generated trapping sites, so as to form qubits, the method comprising the steps of:
determination of parameters for the trapping sites depending upon the set of predetermined tasks following the implementation of a method as described hereinabove, and
configuration of the generator of trapping sites, so as to generate trapping sites according to the parameters determined according to the tasks to be treated;

According to other particular embodiments, the configuration method comprises one or more of the following features, taken individually or according to all technically possible combinations:
the quantum processor comprises a vacuum chamber wherein atoms are generated, the generator of trapping sites comprising:
   a laser device apt to generate a laser beam,
   an optical system for directing the laser beam into the vacuum chamber, and
   a spatial light modulator apt to impart a phase to the laser beam, the phase being apt to be converted into an intensity pattern when the laser beam is in the vacuum chamber, the intensity pattern corresponding to atom trapping sites, the phase of the spatial light modulator being chosen according to the parameters determined for the trapping site;
at the end of the configuration step, the trapping sites are configured for the processing by the quantum processor of a given subset of tasks, the method comprising a step of operating the quantum processor with said configuration of trapping sites, the operating step comprising:
   the formation of a first network of qubits for the processing of a first predetermined task among the tasks of the given subset by trapping atoms in effective sites corresponding to the first predetermined task,
   the processing of the first predetermined task by the first network of qubits,
   the formation a second network of qubits for processing a second predetermined task among the tasks of the given subset by trapping atoms in effective sites corresponding to the second predetermined task, the second task being distinct from the first task, and
   the processing of the second predetermined task by the second network of qubits.

The present description further relates to a computer program product on which is stored a computer program comprising program instructions, wherein the computer program can be loaded on a data processing unit and leads to the implementation of a determination method such as described hereinabove when the computer program is implemented on the data processing unit.

The present description further relates to a readable information medium on which is stored a computer program product such as described hereinabove.

### BRIEF DESCRIPTION OF DRAWINGS

Other features and advantages of the invention will appear upon reading hereinafter the description of the embodiments of the invention, given only as an example, and making reference to the following drawings, which are:

FIG. 1, a schematic example of a quantum processor,

FIG. 2, a flowchart of an example of implementation of a method for determining parameters for a set of atom trapping sites and of a configuration method for a quantum processor,

FIG. 3, an illustrative example of the principle of the method for determining parameters for a set of atom trapping sites.

### DETAILED DESCRIPTION OF EMBODIMENTS

The method for determining parameters and the configuration method which will be described hereinafter in the description are carried out for a quantum processor, also called a quantum computer.

A quantum processor is a network of qubits (also called qubit register), as well as hardware for manipulating the qubits. A quantum processor is suitable for performing quantum operations on qubits.

A quantum processor uses quantum properties of matter, such as superposition and entanglement, to perform operations on the data. Unlike a conventional computer based on transistors working on binary data (coded on bits, 0 or 1), the quantum processor works on qubits the quantum state of which can take a number of values, no longer discrete but continuous.

More particularly, a qubit refers to a two-level quantum mechanical system. For example, a qubit comprises two basic quantum states 10> and 11> representing the possible quantum states of the qubit. According to the superposition principle of quantum mechanics, any superposition of the form al0>+bl1> (a and b being complex numbers and aa*+bb*=1) is a possible quantum state of the qubit.

The quantum processor considered during the implementation of the present method comprises neutral atoms suitable for being manipulated to form the qubits. The manipulations are performed by light beams, such as lasers.

A neutral atom is an electrically neutral atom. Such neutral atoms are e.g. excited to Rydberg levels during the use of the quantum processor. The neutral atoms are e.g. rubidium atoms.

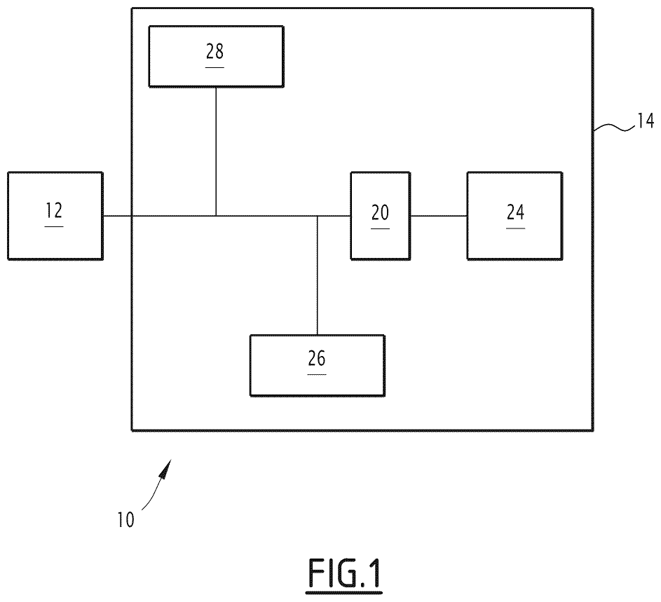

In the example shown in FIG. 1, the quantum processor 10 is a neutral-atom quantum processor. Such a quantum processor 10 comprises a vacuum chamber 12 and a generator 14 of atom trapping sites.

The vacuum chamber 12 is an enclosure wherein the atoms are generated. More particularly, the vacuum chamber 12 is placed under vacuum and comprises a dilute atomic vapor for the formation of neutral atoms.

The generator 14 of atom trapping sites comprises a laser device 20 and a spatial light modulator 24. As illustrated in FIG. 1, the generator 14 further comprises a device 26 for rearranging atoms and a display device 28.

The laser device 20 is apt to generate a laser beam apt to be directed into the vacuum chamber 12, possibly via an optical system.

The spatial light modulator 24 is apt to impart a phase to the laser beam. The phase is suitable for being converted into an intensity pattern when the laser beam is in the vacuum chamber 12. The intensity pattern corresponds to atom trapping sites (optical tweezers). Typically, the vacuum chamber 12 comprises a lens apt to focus the laser beam and the intensity pattern is formed at the focal plane of the lens.

The rearrangement device 26 is suitable for rearranging the atoms trapped in the trapping sites. The rearrangement device 26 comprises e.g. an acousto-optic deflector (AOD) for a laser beam, generating a laser beam apt to be superposed on the laser beam generated by the laser device 20, e.g. via a polarizing beam splitter (PBS).

The display device 28 is apt to generate an image of the trapping sites, serving to display any atoms trapped in the trapping sites. The display device 28 comprises e.g. a dichroic mirror and a camera. The dichroic mirror is apt to separate the fluorescent light emitted by the atoms trapped in the trapping sites from the light corresponding to the laser beams, and to send the fluorescent light onto the camera. The camera is apt to generate an image depending upon the received fluorescent light.

The components of such a neutral-atom quantum processor are e.g. described in detail in paragraph 2 of the article by Loïc Henriet, Lucas Beguin, Adrien Signoles, Thierry Lahaye, Antoine Browaeys, Georges-Olivier Reymond, and Christophe Jurczak. Quantum computing with neutral atoms. Quantum, 4:327, September 2020. ISSN 2521-327X. doi:10.22331/q-2020-09-21-327.

Preferably, at least certain steps of the method for determining the parameter of the trapping sites are implemented by another computer (either classical or quantum), i.e. by a calculator interacting with a computer program product.

In such case, the calculator includes e.g. a processor comprising a data processing unit, memories, a data storage medium reader and optionally a human-machine interface, such as a screen, and a display.

The computer program product includes a data storage medium. The data storage medium is a medium readable by the calculator, usually by the data processing unit. The readable storage medium is a medium suitable for storing electronic instructions and apt to be coupled to a bus of a computer system. The computer program containing program instructions is stored on the data storage medium.

The computer program can be loaded into the data processing unit and is suitable for leading to the implementation of a method for determining trapping sites when the computer program is implemented on the processing unit of the calculator.

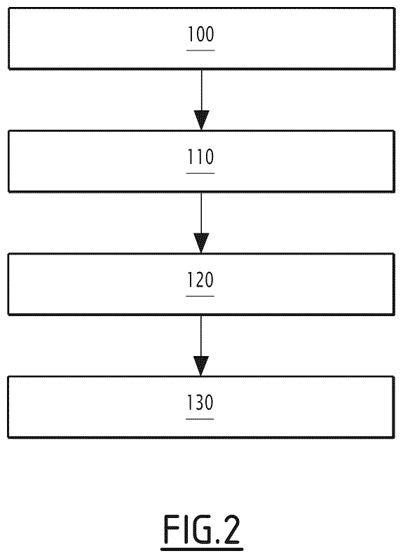

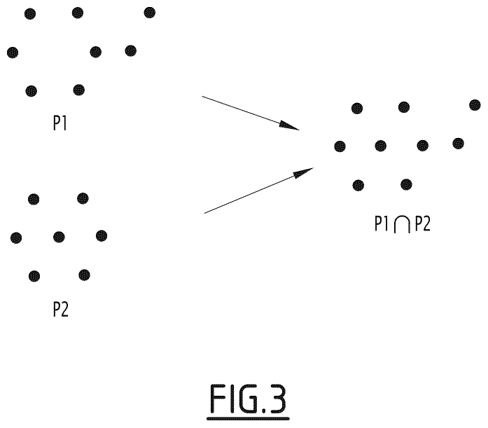

An example of configuration method for a quantum processor 10 will now be described with reference to the flowchart shown in FIG. 2 and FIG. 3 illustrating certain steps of the method.

The configuration method implements steps 100 and 110 of a method for determining parameters of trapping sites, as well as a configuration step 120 and, where appropriate, an operation step 130.

The determination method aims to determine parameters for a set of atom trapping sites in order to form a plurality of networks of qubits for the processing, by a quantum processor 10, of a set of predetermined tasks. More particularly, each predetermined task of the set is suitable for being processed by a network of qubits different from the other tasks.

The parameters define at least a number of trapping sites and a spatial layout of the trapping sites.

Each network of qubits is suitable for being formed by atoms trapped in trapping sites of the set of sites, called effective sites. The other trapping sites, referred to as reservoir sites, are empty for the network of qubits considered. More particularly, the reservoir sites are suitable for trapping atoms that can be used to feed the effective sites during the formation of the network of qubits considered. In such case, the atoms trapped in the reservoir sites can be manipulated by optical tweezers in order to supply the effective sites.

For example, each predetermined task in the set corresponds to the implementation of classification operations on a task-specific graph. The graph has vertices and edges. The vertices of each graph define the positions of the specific matrix of the corresponding task. More particularly, each task corresponds to the application of a sequence of pulses on the atoms forming the network of qubits and which have been arranged so as to reproduce the topology of the graph corresponding to the task, in order to generate a signal allowing classification operations to be performed on the graph.

In another example, each predetermined task in the set corresponds to solving an optimization problem, such as a quadratic unconstrained binary optimization (QUBO) problem. In such case, each task corresponds to the application of a sequence of pulses on the atoms forming the network of qubits, for solving the optimization problem.

The determination method is e.g. implemented by a calculator in interaction with the computer program product, i.e. is computer-implemented.

The determination method comprises a step 100 of obtaining, for each predetermined task, position matrix, called the specific matrix. Each specific matrix defines a number and positions of effective sites forming a network of qubits suitable for processing the predetermined task when an atom is trapped in each effective site. In other words, each specific matrix defines a filling of effective sites by atoms serving to form a network of qubits suitable for processing the task.

The predetermined tasks are apt to be distributed into subsets of tasks. In such case, each subset of tasks is formed of tasks distinct from the other subsets and is such that each task is in only one subset. Preferably, each subset comprises more than two tasks.

The determination method comprises a step 110 of determining, depending upon the specific matrices obtained, a generic matrix of positions for each subset of predetermined tasks, called the generic matrix. The generic matrix is different from each specific matrix in the corresponding task set. More particularly, the set of trapping sites defined by the generic matrix is strictly greater than the set of effective sites defined by each specific matrix.

The generic matrix defines trapping site positions satisfying a set of constraints. At least one constraint stipulates that each position of the specific matrix of each task of the subset considered corresponds to a position, called the effective position, in the generic matrix. For each predetermined task, the trapping sites apt to be positioned at the effective positions of the generic matrix correspond to effective trapping sites, so as to form a network of qubits apt to process the predetermined task when an atom is trapped in each effective site. The trapping sites apt to be positioned at the other positions of the generic matrix form reservoir sites.

For each subset of tasks, the generic matrix and the set of actual positions corresponding to each task in the subset form the parameters of trap sites of the subset of tasks. More particularly, the generic matrix defines a common pattern for positioning the atoms of the tasks of the subset. The specific matrix of each task defines the specific positions of atoms for each task.

Preferably, at least one constraint stipulates that the number of trapping sites defined by the generic matrix is equal to twice the largest number of effective sites among each predetermined task of the subset considered. Indeed, after the loading of the atoms in the trapping sites, each optical tweezer accommodates an atom in about 50% of cases, the optical tweezer otherwise being empty. There is thus a need for “reservoir” sites to fill the optical tweezers composing the desired geometry, which are empty after the loading phase. In the context of the present invention, for each particular register geometry P, sites of the common pattern that are not part of P can be used as reservoir sites.

In a particular example of implementation, the determination step 110 comprises a sub-step of distributing predetermined tasks into subsets depending upon the specific matrices obtained. The distribution sub-step includes:
the determination of a matrix of distances between each specific matrix, and
the distribution of predetermined tasks into subsets according to distance matrices determined by a clustering technique.

Advantageously, the clustering technique is based on a K-means clustering algorithm. In a variant, other clustering algorithms are used.

In an example implementation (which can be combined with the preceding example), the determination step includes, for each subset, the sub-steps of:
provision of a reference matrix defining positions of atom trapping sites according to a reference pattern. The reference pattern is e.g. a triangular lattice.
determination, for a predetermined task of the subset, of positions of the reference matrix, called generic positions. The number of generic positions is equal to the number of effective site positions of the specific matrix of the task.
The generic positions are e.g. the positions of the reference matrix for which a distance from the positions of the specific matrix is minimal.

The preceding determination sub-step is repeated for other predetermined tasks so as to maximize the overlap with the generic positions already determined. Repetition takes place until an end of repetition criterion is reached. The set of generic positions determined form positions of trapping sites of the generic matrix.

Advantageously, the end of repetition criterion is reached when the number of generic positions is equal to a predetermined number. The set of generic positions then form the set of positions of trapping sites of the generic matrix. The determination step then comprises a possible sub-step of determining the positions of the effective sites of each possible predetermined task remaining among the only generic positions so as to minimize a distance with the positions of the specific matrix of the remaining task considered.

In a variant, the end of repetition criterion is reached when all the predetermined tasks of the subset have been taken into account.

Thereby, the main idea is to define an underlying lattice, on which different register geometries can be integrated. In this way, there is no need to modify the SLM pattern for executions on the quantum processor using different register geometries. Said idea is illustrated in FIG. 3 on a very simple case: if a first task requires atoms at positions defined by the pattern P1, and a second task requires atoms at positions defined by the pattern P2, the intersection of P1 and P2 can be taken as the common pattern. Once a common model is found to accommodate multiple register geometries, only the sites needed in each case are filled in.

In a variant, the positions of the trapping sites of the generic matrix are directly determined depending upon specific matrices, without any reference matrix.

Thereby, once the determination process has been completed, parameters for the trapping sites are determined for each subset of the set of predetermined tasks.

The configuration method then comprises a step 120 of configuration for the generator of trapping sites 14 so as to generate trapping sites according to the parameters determined according to the tasks to be processed. More particularly, thereof means choosing the phase of the spatial light modulator 24 according to the parameters determined for the trapping sites.

At the end of the configuration step 120, the trapping sites are configured for the processing by the quantum processor 10 of a given subset of tasks.

The configuration method comprises a step 130 of operating the quantum processor 10 with said configuration of trapping sites. The operation step 130 comprising at least the following sub-steps:
the formation of a first network of qubits for the processing of a first predetermined task among the tasks of the given subset by trapping atoms in effective sites corresponding to the first predetermined task,
the processing of the first predetermined task by the first network of qubits,
the formation of a second network of qubits for processing a second predetermined task among the tasks of the given subset, by trapping atoms in effective sites corresponding to the second predetermined task, the second task being distinct from the first task, and
the processing of the second predetermined task by the second network of qubits.
If appropriate, the training and processing sub-steps are repeated for other tasks of the subset.

When the tasks to be processed correspond to another subset of tasks, a new configuration of the trapping sites corresponding to said subset of tasks is implemented.

A person skilled in the art would understand that the embodiments described hereinabove are likely to be combined with one another when such combinations are compatible.

Thereby, the present method serves to determine parameters defining a network of atom trapping sites, common for the processing of a plurality of predetermined tasks. The trapping sites of the network are then supplied or not supplied with atoms according to the specificities of each task so as to form a specific network of qubits for processing the task.

The common network of atom trapping sites makes it possible to dispense with the time required to implement a new geometry by modifying the phase model on the SLM, and thus significantly reduces the reconfiguration time of the geometry of a network of qubits.

Furthermore, it should be noted that the present method is of particular interest for quantum computing platforms, e.g. proposed by suppliers of computer hardware. Indeed, on such platforms, the demand from users often far exceeds the supply of equipment and there are different planning approaches. Reservation-based approaches are very rigid and impractical for users and queue-based access is generally preferred. A simplistic approach is to set in a queue all user jobs and send the jobs to the available quantum processors. However, due to the high cost of modifying SLM models, such approach is inefficient.

In order to effectively exploit the flexibility of neutral atomic platforms while not affecting access times, the present method allows the user to define an underlying lattice on which the user would integrate a plurality of registers. Thereof would thereby make it possible to execute a plurality of tasks in only one batch of jobs with only one SLM pattern to be calculated, and hence a considerable saving of time.

### EXAMPLES OF IMPLEMENTATION OF THE INVENTION

### 1^{st} Example

We describe hereinafter an example of the implementation of the determination step 110 of the configuration method so as to cluster different register geometries in a common underlying SLM pattern. Such method was implemented in order to have common SLM models apt to accommodate many different graphs from a PTCFM (chemical compounds) dataset.

First, a distance measurement is defined for comparing the graphs of the set of data. Thereof gives a matrix of distances for all the graphs of the set of data. A k-means algorithm is then applied to the distance matrix to determine the close graphs in the integrated space. For each group, an optimal SLM model is then determined.

More precisely, let D={x₁, . . . , x_{N}} be a set of data of the positions of N graphs. Given the desired number of K groups and the desired number of trapping sites per SLM pattern, it is desired to distribute the set of data into K groups, where each group has its own SLM pattern. The desired number of trapping sites is at least twice the largest number of trapping sites corresponding to each graph.

Firstly, a distance d is defined between two graphs, which reflects the extent to which two graphs can be overlaid. For example, the overlay may be significant if both graphs have a hexagon. In such case, one defines:

$${d}_{hexa} ( {G}_{1} , {G}_{2} ) = 1 - {e}^{- α \vert {h}_{1} - {h}_{2} \vert}$$

Where:
G₁ refers to a first graph,
G₂ refers to a second graph,
h₁ is the number of hexagons in G₁,
h₂ is the number of hexagons in G₂, and
e^{X} is the exponential function of X.

Similarly, other distances can be defined, such as e.g. the distance dₚₑₙₜₐ if the two graphs considered have a pentagon.

In a variant, the distance d is a combination of all defined distances and may depend on the structure of the graphs in the dataset. In the case of the PTCFM dataset, the molecules are organic and many of the molecules contain one or a plurality of benzene rings with 6 carbon atoms, which naturally takes the form of a hexagon because same is the most chemically stable geometric arrangement. The distance d=dₕₑₓₐ is thus used for said set of data.

The matrix of distances (matrix of the distances between the different graphs) is then built. From the matrix of distances, K groups are determined using a K-clustering automatic learning method.

An example wherein the trapping sites can only be a subset of an underlying grid r={r₁, . . . , rₘ} consisting of m accessible trapping sites is described in detail hereinafter. It should be noted that the underlying grid can have very different geometries. In the case of PTCFM, it is suitable to choose a triangular grid.

Let B={G₁, . . . , Gₖ} be a group composed of k UD graphs sorted by increasing sizes with known free space positions. The first graph G₁ is suitable for the underlying grid using rotations, translations, and scaling in order to ensure that the suitable graph is similar in shape to the first graph G₁ (to keep the same interaction structure). Once an optimal overlap is found, the coordinates of the corresponding trapping sites are stored as marked trapping sites. For the second graph G₂, the optimization of the overlap makes it possible to preserve the initial structure of the second graph G₂ but will also attempt to maximize the overlap with the marked trapping sites. Once an optimal overlap is found, the new trapping sites are added to the marked trapping sites.

The procedure is repeated until (1) the number of marked trapping sites equals the desired number of trapping sites or (2) all graphs have been processed. In the case of condition (1), all remaining graphs will be processed at the marked trapping sites, without any possibility of adding new trapping sites. For condition (2), if the number of marked trapping sites is at least 2×|Gₖ|, the procedure ends. If the number is lower, then Gₖ, being the largest graph in the group, will not have enough spare trapping sites to be fully loaded. A number of trapping sites is thus added to obtain the desired number of trapping sites.

Such a method was tested on data corresponding to the 1^{st} example. During the experimental implementation, 289 graphs of less than 30 nodes of the PTCFM set of data were considered and divided into groups. For all graphs in the same group, a common SLM pattern was used. Group 0 contains 62 graphs ranging in size from 2 to 19 nodes. Group 1 contains 80 graphs ranging in size from 3 to 20 nodes. The 2 group contains 66 graphs with sizes between 4 and 19 nodes. The 3 group contains 57 graphs with sizes between 6 and 20 nodes. The 4 group contains 24 graphs with a size varying from 7 to 18 nodes.

It appears that the time required to generate an SLM model including up to 100 trapping sites is generally 10 to 15 minutes, including the generation of a first model, the equalization procedure to optimize same and the validation by atomic measurements. Same increases for larger models but does not decrease significantly for smaller models. Once a pattern is generated on the SLM, the quantum processor is apt to be programmed to indicate which trapping sites are selected to generate the target graph. Consequently, defining an SLM pattern for each graph results in an additional time cost proportional to the number of graphs that can be clustered. The groups having sizes ranging from 24 to 80 graphs, on average 4 to 20 hours per group are saved during the generation of SLM common patterns, a very significant reduction in time.

To correctly estimate the time saved with such method, the consequences of clustering graphs on the data production rate are also taken into account. If an SLM model is used for each graph, it can be done with the number of tweezers that will maximize the efficiency of the rearrangement procedure (usually just over twice the size of the graph). If an SLM model common to a plurality of graphs is used, the number of tweezers may be greater than said figure.

More tweezers means more movements to produce the correct graph, thereby decreasing the overall efficiency. To study all graphs with similar statistics, it is thus recommended to execute more repetitions with a common SLM model than with individual models. For the data set presented herein, thereof would lead to an average of 25% additional executions, which corresponds to an additional cost of time to acquire 400 repetitions ranging from 0.5 to 2 hours for a group of 20 to 80 graphs. Thereof remains relatively negligible compared with the time saved by generating SLM patterns. The proposed method therefore significantly reduces the configuration time of a quantum processor with neutral atoms.

2^{nd} example: In the case of QUBO problems and a neutral-atom processor, each QUBO problem corresponds to a positioning of the neutral atoms for solving the problem. In such case, the positions of the atoms for each QUBO problem (corresponding to a task) were determined by a machine learning tool.

Thereby, when trying to solve several QUBO problems (say M QUBO), the corresponding positions of neutral atoms (i.e. M sets of atoms) generally correspond to different geometries.

The present configuration method then serves to generate a common SLM model for a plurality of QUBOs by restricting the positions of the atoms to an underlying dense network (e.g. a triangular network). In practice, for each incorporation, each atom is moved to the closest site of the lattice.

By then taking the union of the M sets of atoms, one obtains a subset S of the underlying lattice. We then consider S as the SLM model, provided that the number of sites in S is always twice as large as the number of atoms in each of the M sets of atoms. The formation of different groups is also a possibility if M is large.

1-10. (canceled)

11. A method for determining parameters for a set of neutral atom-trapping sites with a view to forming a plurality of networks of qubits allowing a quantum processor to process a set of predetermined tasks, the parameters defining at least a number of trapping sites and a spatial layout of the trapping sites, each network of qubits being able to be formed by atoms trapped in trapping sites, referred to as effective sites, of the set of sites, the other trapping sites, referred to as reservoir sites, being empty for the network of qubits under consideration, the reservoir sites being able to trap atoms that are able to be used to supply the effective sites during the formation of the network of qubits under consideration, the method being implemented by a computer and comprising the following steps:
a. obtaining, for each predetermined task, a matrix of positions, called a specific matrix, each specific matrix defining the positions of effective sites forming a network of qubits suitable for processing the predetermined task when an atom is trapped in each effective site, the predetermined tasks being suitable for being distributed into subsets of tasks, and
b. the determination, according to the specific matrices obtained, of a matrix of generic positions, called the generic matrix, for each subset of predetermined tasks, the generic matrix being different from each specific matrix of the concerned subset,
the generic matrix defining positions of trapping sites complying with a set of constraints, at least one constraint stipulating that each position of the specific matrix of each task of the considered subset corresponds to a position, called the effective position, in the generic matrix, for each predetermined task, the trapping sites apt to be positioned at the effective positions of the generic matrix corresponding to effective trapping sites for forming a network of qubits apt to process the predetermined task when an atom is trapped in each effective site, and the trapping sites apt to be positioned at the other positions of the generic matrix forming reservoir sites,
for each subset of tasks, the generic matrix and the set of actual positions corresponding to each task in the subset, forming the parameters of the trap sites of the subset of tasks.

12. The determination method according to claim 11, wherein the specific matrix of each predetermined task of each subset defines a number of effective sites for processing the predetermined task, at least one constraint stipulating that the number of trapping sites defined by the generic matrix is equal to twice the largest number of effective sites among each predetermined task of the considered subset.

13. The determination method according to claim 11, wherein determination step comprises a sub-step of distributing predetermined tasks into subsets according to the obtained specific matrices, the distribution sub-step comprising:
a. the determination of a matrix of distances between each specific matrix, and
b. the distribution of the predetermined tasks into subsets, according to a clustering technique, depending upon the determined distance matrices.

14. The determination method according to claim 13, wherein the clustering technique is based on a K-means clustering.

15. The determination method according to claim 11, wherein:
a. each task corresponds to the implementation of classification operations on a graph specific to the task, each graph having vertices and edges, the vertices of each graph defining the positions of the specific matrix of the corresponding task, or
b. each task corresponds to solving an optimization problem, such as a quadratic unconstrained binary optimization problem.

16. The determination method according to claim 11, wherein the determination step comprises, for each subset, the sub-steps of:
a. provision of a reference matrix defining positions of atom trapping sites according to a reference pattern,
b. determination, for a predetermined task of the subset, of positions of the reference matrix, referred to as generic positions, the number of generic positions being equal to the number of effective site positions of the specific matrix of the task, the generic positions being the positions of the reference matrix for which a distance from the positions of the specific matrix is minimal,
the preceding determination sub-step being repeated for other predetermined tasks so as to maximize overlap with the generic positions already determined, the repetition taking place until an end of repetition criterion is reached, the set of generic positions determined forming trapping site positions of the generic matrix.

17. The determination method according to claim 16, wherein the end of repetition criterion is reached when the number of generic positions is equal to a predetermined number, the set of generic positions forming the set of trapping site positions of the generic matrix, the determination step comprising a sub-step of determining the positions of the effective sites of each predetermined task remaining among the generic positions alone, so as to minimize a distance from the positions of the specific matrix of the remaining task considered.

18. A configuration method for a quantum processor for processing a set of predetermined tasks, the quantum processor comprising a generator of neutral atom trapping sites and neutral atoms apt to be trapped in the generated trapping sites, so as to form qubits, the method comprising the steps of:
a. determination of parameters for the trapping sites depending upon the set of predetermined tasks following the implementation of a method according to claim 11, and
b. configuration of the generator of trapping sites, so as to generate trapping sites according to the parameters determined according to the tasks to be treated.

19. The configuration method according to claim 18, wherein the quantum processor comprises a vacuum chamber wherein the atoms are generated, the generator of trapping sites comprising:
a. a laser device apt to generate a laser beam,
b. an optical system for directing the laser beam into the vacuum chamber, and
c. a spatial light modulator apt to impart a phase to the laser beam, the phase being apt to be converted into an intensity pattern when the laser beam is in the vacuum chamber, the intensity pattern corresponding to atom trapping sites, the phase of the spatial light modulator being chosen according to the parameters determined for the trapping.

20. The configuration method according to claim 18, wherein at the end of the configuration step, the trapping sites are configured for the processing by the quantum processor of a given subset of tasks, the method comprising a step of operating the quantum processor with said configuration of trapping sites, the operating step comprising:
a. the formation of a first network of qubits for the processing of a first predetermined task among the tasks of the given subset by trapping atoms in effective sites corresponding to the first predetermined task,
b. the processing of the first predetermined task by the first network of qubits,
c. the formation of a second network of qubits for processing a second predetermined task among the tasks of the given subset, by trapping atoms in effective sites corresponding to the second predetermined task, the second task being distinct from the first task, and
d. the processing of the second predetermined task by the second network of qubits.

21. A computer program product including a readable storage medium on which is stored a computer program comprising program instructions, wherein the computer program can be loaded on a data processing unit and leads to implementing a determination method according to claim 11 when the computer program is implemented on the data processing unit.
